(19) United States
(12) Patent Application Publication
(10) Pub. No.: US 2009/0308159 A1
(43) Pub. Date: Dec. 17, 2009

(54) Micromechanical Acceleration Sensor

(76) Inventors: Volker Frey, Wangen (DE); Christian Ohl, Pfullingen (DE); Holger Wolfmayr, Pfullingen (DE); Harald Emmerich, Kusterdingen (DE)

Correspondence Address: KENYON & KENYON LLP, ONE BROADWAY, NEW YORK, NY, 10004, US

(21) Appl. No.: 12/227,918

(22) PCT Filed: Apr. 10, 2007
(86) PCT No.: PCT/EP2007/053457

§ 371 Date: Aug. 10, 2009

(30) Foreign Application Priority Data
Jun. 9, 2006 (DE) 10 2006 026 880.6

(51) Int. Cl. G01P 15/125

(52) U.S. Cl. 73/514.32

(57) ABSTRACT

With a sensor having a centrifugal mass in the form of a balancing rocker which is deflectable in the z-direction, to avoid asymmetrical clipping in the case of lever arms of the balancing rocker that are of different lengths, a limit-stop device, which shortens the possible deflection, is provided on the side of the shorter lever arm, or, in the case of lever arms of equal length, at least one additional mass disposed on the side on one lever arm is provided, so that the maximum mechanical deflection of the centrifugal mass is of equal magnitude on both sides of the asymmetrical balancing rocker.

### FIELD OF THE INVENTION

The present invention relates to a micromechanical acceleration sensor, having a substrate with an anchoring device, and having a rotating mass in the form of a balancing rocker, which has an asymmetrical geometry with respect to its torsion axis and which is joined to the anchoring device via a spiral spring device, thereby making the rotating mass elastically deflectable from its neutral position by accelerations acting perpendicular to the substrate.

### BACKGROUND INFORMATION

An acceleration sensor having a sensing axis in the z-direction is described in German Patent Application No. DE 100 00 368, for example. The balancing rocker of the known sensor has lever arms of different lengths.

Acceleration sensors have been used for years as crash sensors in vehicles for the detection of side impacts, front crashes or also to detect the severity of a crash in the front region. For approximately the last decade, acceleration-sensitive sensors having a sensing axis in the x-direction, i.e., parallel to the chip plane, which are produced by surface-micromechanical methods and have an interdigital structure, have been on the market. These sensors include two components that engage with one another in the form of fingers or combs. Under the action of an acceleration, these components move relative to each other, transversely to the chip plane, and plunge into each other to a greater or lesser extent. Lately, there has also been increased use of what is generally known as “z-sensors”, which do not have an interdigital structure but a movable balancing-rocker structure exposed micromechanically and made from polysilicon, which enables an elastic vertical sensitivity of the sensor, i.e., a detection direction with regard to acceleration that extends perpendicular to the chip plane. In order to obtain an electrical signal from the deflection of the balancing rocker, the acceleration sensor typically includes a differential-capacitor array made up of electrodes affixed on the torsion body, i.e., the balancing rocker, and of stationary counter-electrodes on the substrate.

Z-sensors having a balancing-rocker structure presuppose a centrifugal mass asymmetrically suspended on the torsion axle, so that the acceleration is able to engage asymmetrically according to the overall torque (i.e., mass times moment arm) about the torsion axis, which is greater on one side of the balancing rocker, and to deflect the balancing rocker from its neutral position. Since a local, unilateral thickening of the balancing-rocker structure is virtually impossible to realize for process-related reasons, the asymmetrical suspension at present is generally realized in such a way that one lever arm of the balancing rocker is longer (and thus also heavier) than the opposite lever arm, cf. FIG. 6 of German Patent Application No. DE 100 00 368. In this way, a larger overall torque is guaranteed to result on the longer side of the lever arm.

Acceleration sensors having a sensing axis in the x- or z-direction have a mechanical limit up to which the movably disposed finger or balancing-rocker structure is deflectable. Once this limit (maximally possible amount of deflection) has been reached, even higher acceleration values will no longer result in a variation of the output signal of the sensor. This phenomenon is also referred to as mechanical clipping. Due to the cutoff of the signal pattern at the clipping limit, the entire information about the signal pattern beyond the clipping limit is lost.

In response to an acceleration acting perpendicular ‘from above’, the end of the longer lever arm of the known z-sensors strikes the substrate earlier, i.e., at a smaller deflection amount, than in response to an acceleration acting ‘from below’ on the other side of the balancing rocker and with respect to the shorter end of the lever arm, so that asymmetrical clipping takes place.

Due to the different clipping limits on the two sides of the asymmetrical balancing rocker, the integration of the acceleration signal disadvantageously cut off by the clipping causes an offset in the data reconstructed from the signal and relating to the velocity reduction in comparison with an integrated, unbiased acceleration signal. This offset therefore constitutes an undesired artifact of the asymmetrical clipping process.

### SUMMARY OF THE INVENTION

The present invention avoids this disadvantage inasmuch as the required additional mass disposed on one side of the balancing rocker and in a plane with the remaining centrifugal mass does not lead to an asymmetrical ‘earlier’ contact of one side of the balancing rocker with the substrate, despite the asymmetrical geometry. With lever arms of the balancing rocker having different lengths, this is accomplished by providing a stop device on the side of the shorter lever arm, which shortens a possible deflection; with lever arms of equal lengths, however, at least one laterally disposed additional mass is provided on one lever arm, so that the maximally possible mechanical deflection of the centrifugal mass in both instances is of equal magnitude on both sides of the asymmetrical balancing rocker. The design according to the present invention thus results in a balancing-rocker structure whose asymmetrical geometry can no longer lead to an asymmetrical clipping.

According to one specific development of the present invention, in which the balancing-rocker structure producible from polysilicon, in particular, has lever arms of equal length, it is advantageous, especially from the aspect of production technology, if the additional mass to be situated on the side of one of the lever arms is embodied as transversal arm of the lever arm.

This specific embodiment may advantageously be further developed by providing the lever arm with transverse arms on both sides, which are positioned symmetrically opposite one another. This results in a development that is especially preferred from the aspect of production technology and with regard to the sensor-mechanical function, inasmuch as the lever arm includes two oppositely positioned transverse arms that extend across its entire length in each case. In this development, the lever arm provided with the additional mass takes the approximate form of a transverse beam.

In the other alternative according to the present invention, which is characterized by lever arms of different length, it is advantageous that the limit-stop device has a limit stop which is fixedly supported on the substrate.

### BRIEF DESCRIPTION OF THE DRAWINGS

FIG. 1a shows a schematic plan view of a first specific embodiment of a sensor having a limit-stop device according to the present invention, which includes a balancing-rocker structure having lever arms of different length.

FIG. 2a shows a second specific embodiment in the same view, in which a balancing-rocker structure with lever arms of equal length is provided.

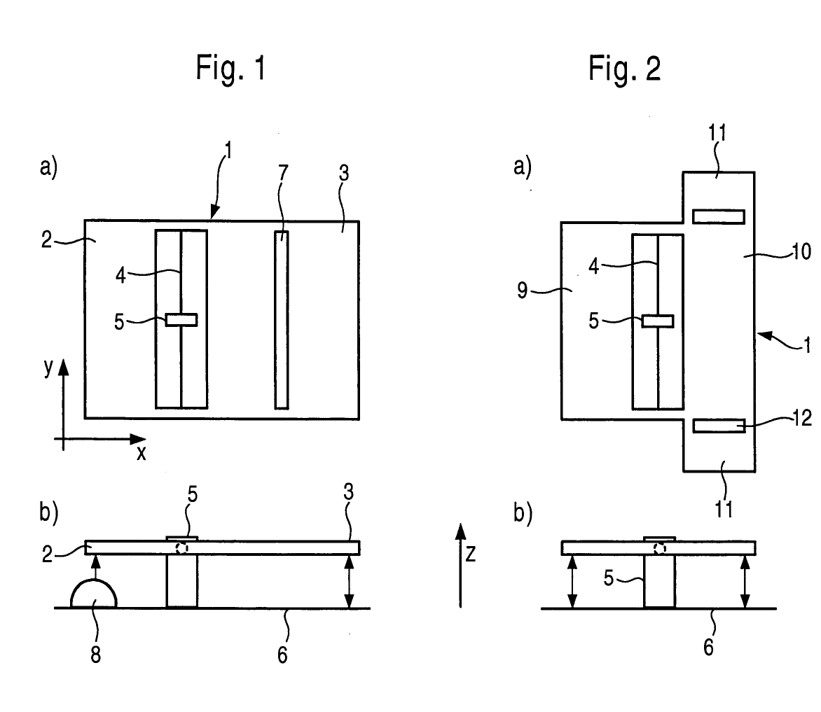

FIGS. 1b and 2b show the first and second specific embodiment in a side view in each case.

### DETAILED DESCRIPTION

FIGS. 1a and 1b show a micromechanically exposed, movable balancing rocker 1 of an acceleration sensor according to the present invention, which is made of polysilicon and according to a first specific embodiment has one shorter lever arm 2 and one longer lever arm 3. With the aid of two torsion springs 4, balancing-rocker structure 1 is suspended on an anchoring device 5, which in turn is anchored on substrate 6. The x-y coordinate axes, which extend parallel to substrate 6, as well as the z-direction, which extends perpendicular thereto, have been defined by arrows in the figures. The longer lever arm has an opening 7, which in the generally known manner contributes to the desired damping characteristics of spring-mass system 1, 4. In this first specific embodiment, the portion of longer lever arm 3 lying to the right of opening 7 forms the additional mass, which is required to implement an asymmetrical placement of the centrifugal mass of the sensor about the torsion axis (torsion springs or spiral springs 4), based on an asymmetrical geometry.

As can be gathered from FIG. 1b, without the additional measures according to the present invention, longer lever arm 3, due to its length, would strike substrate 6 at a smaller deflection amount (angle) in response to an acceleration acting from above (i.e., in negative z-direction), than shorter lever arm 2 in response to an acceleration acting from below (i.e., in the positive z-direction). This would lead to unintended, asymmetrical clipping in the manner described in the introduction. The present invention therefore provides a limit stop 8, which is situated underneath shorter lever arm 2 and fixedly supported on substrate 6, the limit stop limiting the maximally possible deflection on this side of balancing rocker 1 to the same deflection amount that is possible for longer lever arm 3 on the other side of balancing rocker 1. (Layer thicknesses and other geometric features, e.g., the height and form of limit stop 8, which is shown here in the form of a hump merely by way of example, are not depicted true to scale in the figures.) For example, limit stop 8 may be produced as an integral component of substrate 6 by increasing the material height, or it may be produced externally and subsequently mounted in the intended location.

FIGS. 2a and 2b shows a balancing-rocker structure 1 in which, despite equally long lever arms 9 and 10, an asymmetrically suspended centrifugal mass is realized by additional masses 11, which are affixed on the side of lever arm 10. Since lever arms 9 and 10 are of equal length, it is simultaneously ensured that none of lever arms 9 or 10 strikes ‘earlier’ than the other, so that only symmetrical clipping results, which is not considered a problem. If, as shown in FIGS. 2a and 2b, lever arm 10 is developed with two transverse arms (additional masses 11) lying symmetrically opposite one another and extending across its entire length in each case, then it is advantageous to provide lever arm 10 with an individual longitudinal opening 12, which extends parallel to lever arm 10, in the region of the transition to transverse arms 11.

It should be mentioned that the present invention is not limited to the developments in which balancing-rocker structure 1 is suspended on an ‘inner’ anchoring 5 as illustrated in the figures. Developments in which balancing-rocker structure 1 is suspended in an external frame are conceivable as well.

1-6. (canceled)

7. A micromechanical acceleration sensor comprising:
a substrate;
an anchoring device;
a centrifugal mass in the form of a balancing rocker, which has an asymmetrical geometry with respect to a torsion axis; and
a spiral spring device for joining the balancing rocker to the anchoring device, thereby making the centrifugal mass elastically deflectable from a neutral position by accelerations acting perpendicular to the substrate,
wherein, so that a maximally possible mechanical deflection of the centrifugal mass is of equal magnitude on both sides of the asymmetrical balancing rocker, one of:
(a) lever arms of the balancing rocker are of different length, and further comprising a limit-stop device, which shortens a possible deflection and is situated on a side of a shorter of the lever arms, and
(b) lever arms of the balance rocker are of equal length, and further comprising at least one laterally disposed additional mass situated on one of the lever arms.

8. The micromechanical acceleration sensor according to claim 7, wherein the lever arms are of equal length, and the additional mass is situated on a side of one of the lever arms and includes a transverse arm of the one of the lever arms.

9. The micromechanical acceleration sensor according to claim 8, wherein the one of the lever arms has transverse arms on both sides, which are situated symmetrically opposite one another.

10. The micromechanical acceleration sensor according to claim 9, wherein the one of the lever arms has two oppositely-lying transverse arms, each of which extends across an entire length.

11. The micromechanical acceleration sensor according to claim 10, wherein each of the lever arms has a longitudinal opening, which extends parallel to the lever arm, in a region of a transition to the transverse arms.

12. The micromechanical acceleration sensor according to claim 7, wherein the limit-stop device has a limit stop, which is fixedly supported on the substrate.
